(19) United States
(12) Patent Application Publication
(10) Pub. No.: US 2019/0126623 A1
(43) Pub. Date: May 2, 2019

(54) INKJET PRINTER WITH WIPER FOR NOZZLE SURFACE

(71) Applicant: RISO KAGAKU CORPORATION, Tokyo (JP)

(72) Inventor: Akira NISHIYAMA, Ibaraki (JP)

(73) Assignee: RISO KAGAKU CORPORATION, Tokyo (JP)

(21) Appl. No.: 16/172,144

(22) Filed: Oct. 26, 2018

(30) Foreign Application Priority Data
Oct. 30, 2017 (JP) 2017-209361

(51) Int. Cl. B41J 2/165; B41J 2/14

(52) U.S. Cl. CPC B41J 2/16538; B41J 2/1433

(57) ABSTRACT

An inkjet printer includes: an inkjet head including nozzles and a nozzle surface tilted in a tilt direction with respect to a horizontal plane; a purging unit configured to discharge ink from the nozzles and attach the discharged ink to the nozzle surface; and a wiper configured to wipe the nozzle surface in a wiping direction orthogonal to the tilt direction. At least a portion of the wiper including an end of the wiper on a lower side in the tilt direction is tilted or curved toward a downstream side in the wiping direction toward the lower side in the tilt direction. The portion of the wiper is configured to wipe the nozzle surface while pushing the ink attached to the nozzle surface from the lower side to an upper side in the tilt direction.

### CROSS REFERENCE TO RELATED APPLICATION

This application is based upon and claims the benefit of priority from the prior Japanese Patent Application No. 2017-209361, filed on Oct. 30, 2017, the entire contents of which are incorporated herein by reference.

### BACKGROUND

### 1. Technical Field

The disclosure relates to an inkjet printer which performs printing by ejecting ink from an inkjet head to a print medium.

### 2. Related Art

In an inkjet printer, maintenance of inkjet heads is performed to reduce failures of ink ejection from the inkjet heads.

As one of maintenance operations for the inkjet heads, Japanese Patent Application Publication No. 2011-68092 discloses a series of operations in which so-called purging is performed to push out ink from nozzles of inkjet heads and then nozzle surfaces are wiped with wipers. In this series of operations, the wipers remove dust and the like on the nozzle surfaces together with the ink discharged from the nozzles by the purging and attached onto the nozzle surfaces.

### SUMMARY

There are inkjet printers which perform printing by ejecting ink from inkjet heads to a long web while continuously conveying the web. Among such inkjet printers, there is an inkjet printer which conveys the web along multiple supporting members arranged in an arch pattern in a portion where the web passes below the inkjet heads of multiple colors. This configuration can apply tension to the web below the heads and stabilize the attitude of the web.

In the inkjet printer as described above, arranging the multiple supporting members in the arch pattern forms a portion where the web is tilted with respect to the horizontal plane, between each pair of adjacent supporting members. Since the inkjet heads are installed such that the nozzle surfaces are parallel to the web, the inkjet heads above the portions where the web is tilted are installed with the nozzle surfaces tilted with respect to the horizontal plane.

In each of the inkjet heads in which the nozzle surfaces are tilted with respect to the horizontal plane, the ink discharged from the nozzles by the purging in the maintenance and attached to portions around the nozzles on the nozzles surface moves to the lower side of the nozzle surface in a tilt direction thereof due to gravity before the nozzle surface is wiped by the wiper. In this case, when the wiper wipes the nozzle surface, the upper side of the nozzle surface in the tilt direction is wiped without the ink which acts as lubricant being present between the nozzle surface and the wiper. An ink repellent film which is formed on the nozzle surface to repel the ink is sometimes degraded by this wiping. The degradation of the ink repellent film leads to an increase in the frequency of inkjet head replacement.

The disclosure is directed to an inkjet printer which can mitigate degradation of an ink repellent film on a nozzle surface of an inkjet head.

An inkjet printer in accordance with some embodiments includes: an inkjet head including nozzles configured to eject ink, and a nozzle surface on which the nozzles open and an ink repellent film is formed, the nozzle surface tilted in a tilt direction with respect to a horizontal plane; a purging unit configured to discharge the ink from the nozzles and attach the discharged ink to the nozzle surface; and a wiper configured to wipe the nozzle surface in a wiping direction orthogonal to the tilt direction with the nozzle surface to which the ink discharged from the nozzles by the purging unit is attached. At least a portion of the wiper including an end of the wiper on a lower side in the tilt direction is tilted or curved toward a downstream side in the wiping direction toward the lower side in the tilt direction, and the portion of the wiper is configured to wipe the nozzle surface while pushing the ink attached to the nozzle surface from the lower side to an upper side in the tilt direction.

An inkjet printer in accordance with some embodiments includes: an inkjet head including nozzles configured to eject ink, and a nozzle surface on which the nozzles open and an ink repellent film is formed, the nozzle surface tilted in a tilt direction with respect to a horizontal plane; a purging unit configured to discharge the ink from the nozzles and attach the discharged ink to the nozzle surface; and a wiper configured to wipe the nozzle surface from a lower side to an upper side in the tilt direction with the nozzle surface to which the ink discharged from the nozzles by the purging unit is attached.

An inkjet printer in accordance with some embodiments includes: an inkjet head including nozzles configured to eject ink, and a nozzle surface on which the nozzles open and an ink repellent film is formed, the nozzle surface set to tilt with respect to a horizontal plane in printing and be horizontal in maintenance; a purging unit configured to discharge the ink from the nozzles of the inkjet head with the nozzle surface being horizontal and attach the ink to the nozzle surface; and a wiper configured to wipe the nozzle surface of the inkjet head with the nozzle surface being horizontal and to which the ink discharged from the nozzles by the purging unit is attached.

In the aforementioned configuration, degradation of the ink repellent film on the nozzle surface of the inkjet head can be mitigated.

### BRIEF DESCRIPTION OF DRAWINGS

FIG. 1 is a schematic configuration diagram of a print system including an inkjet printer according to a first embodiment.

FIG. 2 is a control block diagram of the print system illustrated in FIG. 1.

FIG. 3 is a perspective view illustrating a schematic configuration of a head unit in the first embodiment.

FIG. 4 is a view illustrating a nozzle surface of an inkjet head.

FIG. 5 is a front view of the head unit illustrated in FIG. 3 in a standby state.

FIG. 6 is a front view of the head unit illustrated in FIG. 3 in printing.

FIG. 7 is a perspective view illustrating a schematic configuration of a maintenance unit in the first embodiment.

FIG. 8 is an enlarged plan view of a main portion of the maintenance unit illustrated in FIG. 7.

FIG. 9 is an explanatory view of a deployed position of the maintenance unit.

FIG. 10 is an explanatory view of a retreat position of the maintenance unit.

FIG. 11 is a view illustrating a state where the ink discharged from the nozzles by purging is attached to the nozzle surface.

FIG. 12 is a view illustrating a state where the ink discharged from the nozzles by the purging and attached to the nozzle surface gathers on the lower side of the nozzle surface in a tilt direction thereof.

FIG. 13 is an explanatory view of a wiping operation by the maintenance unit illustrated in FIG. 7.

FIG. 14 is an explanatory view of a wiper with a curved shape.

FIG. 15 is an explanatory view of a wiping operation by the wiper illustrated in FIG. 14.

FIG. 16 is an explanatory view of a wiper with a bent shape.

FIG. 17 is an explanatory view of a wiping operation by the wiper illustrated in FIG. 16.

FIG. 18 is an enlarged plan view of amain portion of each of a maintenance unit in a second embodiment.

FIG. 19 is a perspective view illustrating a schematic configuration of a maintenance unit in a third embodiment.

FIG. 20 is a plan view of the maintenance unit illustrated in FIG. 19.

FIG. 21 is an explanatory view of a wiping operation by the maintenance unit illustrated in FIG. 19.

FIG. 22 is a front view of a head unit in a fourth embodiment in the standby state.

FIG. 23 is a front view of the head unit in the fourth embodiment in the printing.

FIG. 24 is an explanatory view of a wiping operation in the fourth embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

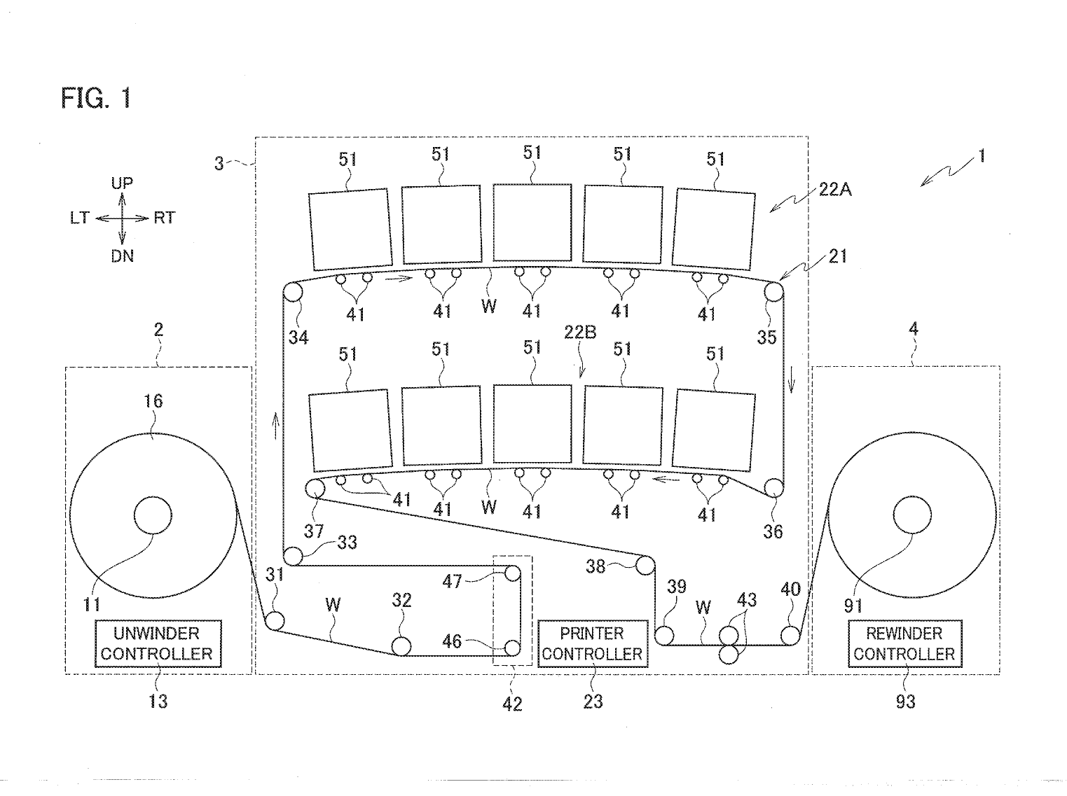

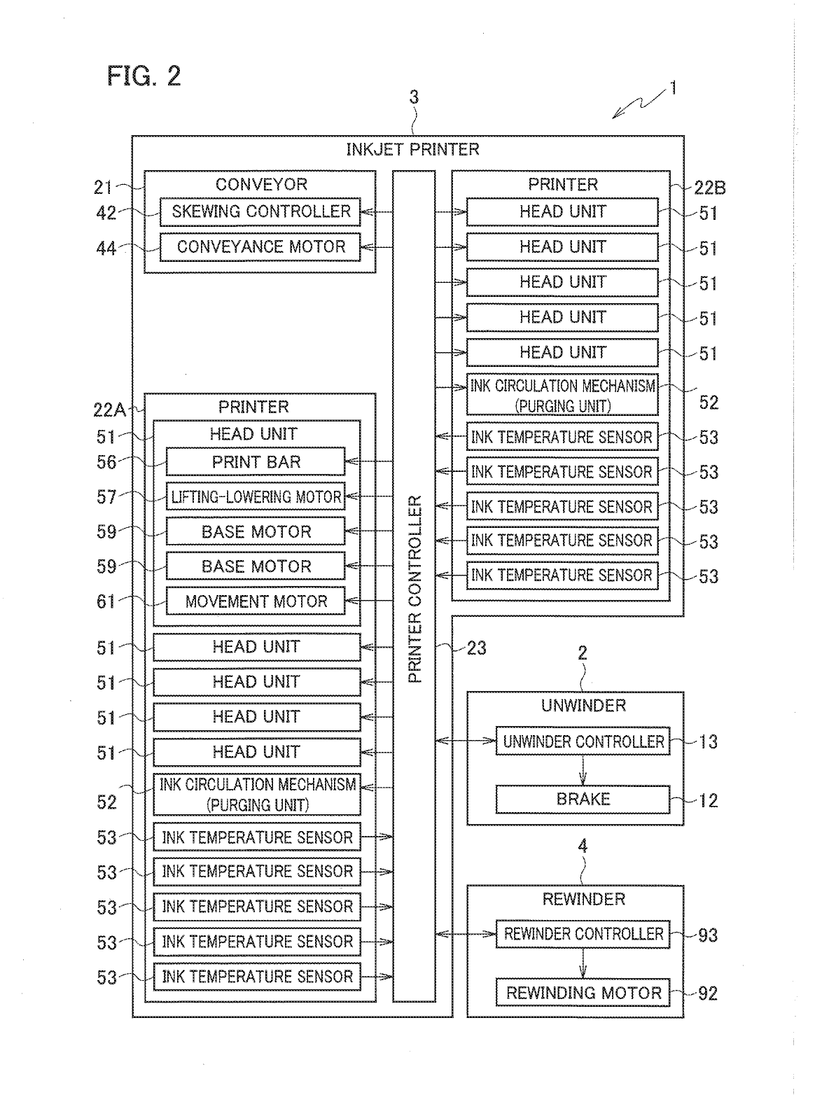

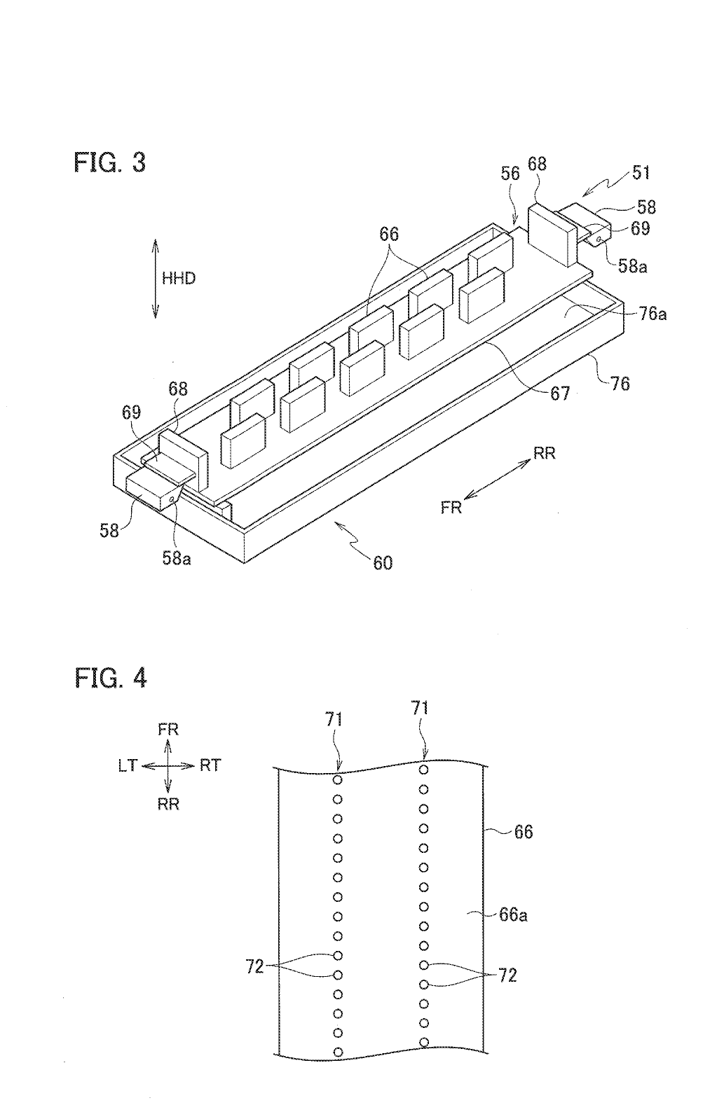

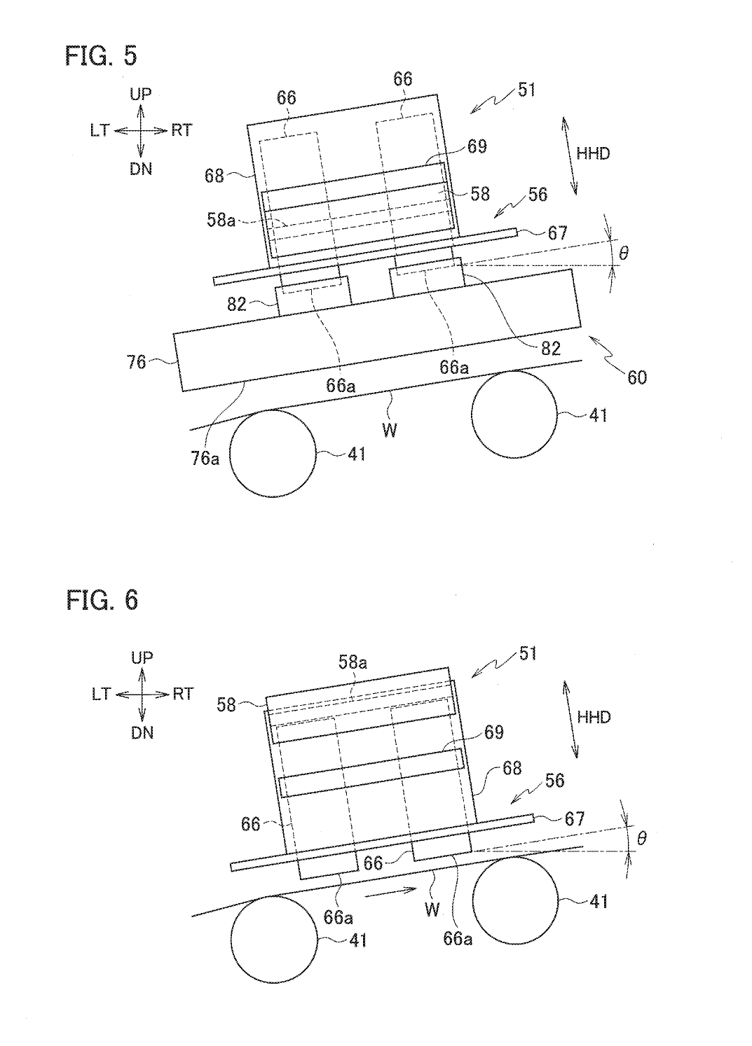

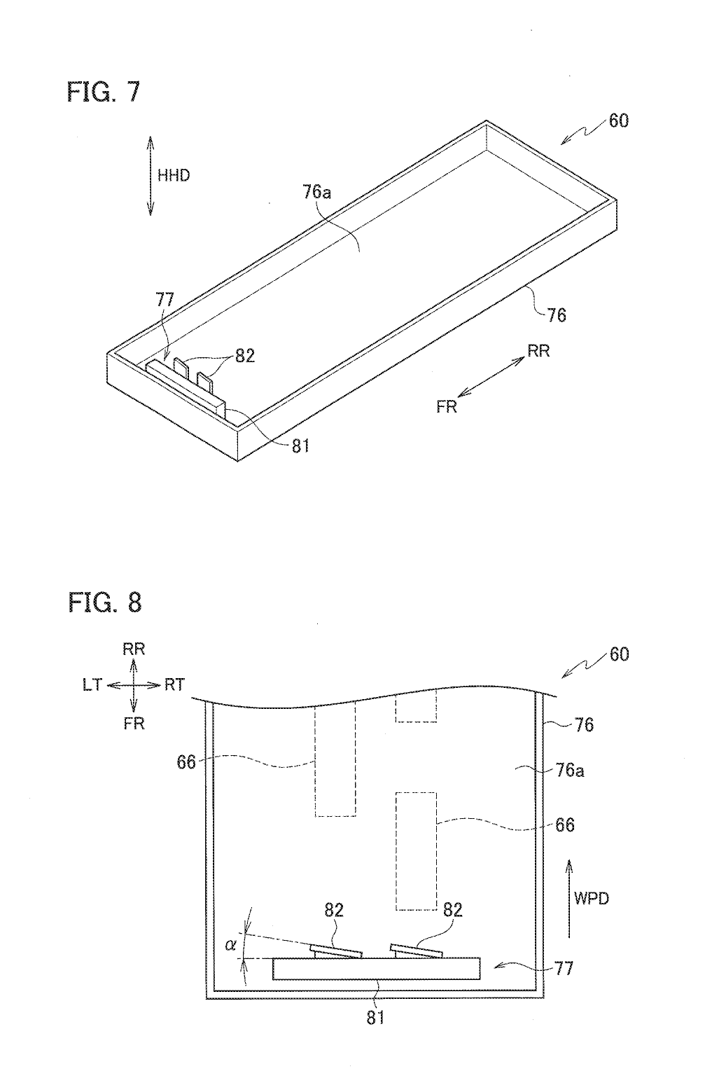

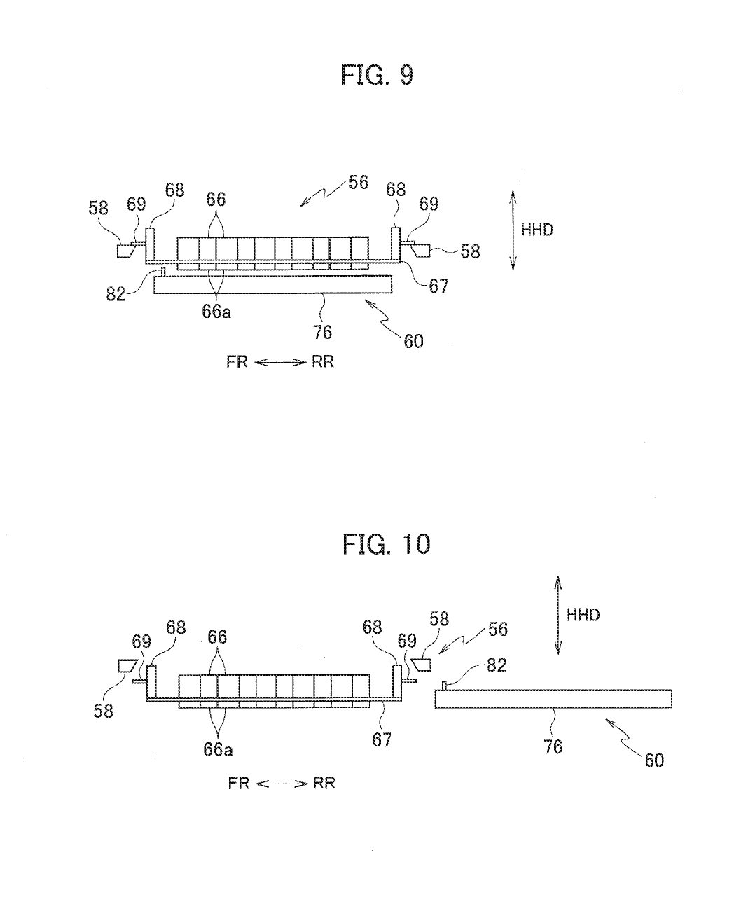

FIG. 1 is a schematic configuration diagram of a print system including an inkjet printer according to a first embodiment of the present invention. FIG. 2 is a control block diagram of the print system illustrated in FIG. 1. FIG. 3 is a perspective view illustrating a schematic configuration of a head unit in the first embodiment. FIG. 4 is a view illustrating a nozzle surface of an inkjet head. FIG. 5 is a front view of the head unit illustrated in FIG. 3 in a standby state. FIG. 6 is a front view of the head unit illustrated in FIG. 3 in printing. FIG. 7 is a perspective view illustrating a schematic configuration of a maintenance unit in the first embodiment. FIG. 8 is an enlarged plan view of a main portion of the maintenance unit illustrated in FIG. 7. FIG. 9 is an explanatory view of a deployed position of the maintenance unit. FIG. 10 is an explanatory view of a retreat position of the maintenance unit.

In the following description, a direction orthogonal to the sheet surface of FIG. 1 is referred to as front-rear direction and a direction toward the viewer is referred to as forward. Moreover, up, down, left, and right in the sheet surface of FIG. 1 are referred to as upward, downward, leftward, and rightward directions. In FIGS. 1 and 3 to 24, the rightward direction, the leftward direction, the upward direction, the downward direction, the forward direction, the rearward direction, a head height direction, a wiping direction, a tilt direction of the nozzle surface, and an ink pushing-up direction are denoted by RT, LT, UP, DN, FR, RR, HHD, WPD, NTD, and IRD, respectively.

As illustrated in FIGS. 1 and 2, a print system 1 according to the first embodiment includes an unwinder 2, an inkjet printer 3, and a rewinder 4.

The unwinder 2 unwinds a web W being a long print medium made of film, paper, or the like to the inkjet printer 3. The unwinder 2 includes a web roll support shaft 11, a brake 12, and an unwinder controller 13.

The web roll support shaft 11 rotatably supports a web roll 16. The web roll 16 is the web W wound into a roll.

The brake 12 applies brake force to the web roll support shaft 11. Tension is thereby applied to the web W between the web roll 16 and a pair of conveyance rollers 43 of the inkjet printer 3 to be described later.

The unwinder controller 13 controls the brake 12. The unwinder controller 13 includes a CPU, a RAM, a ROM, a hard disk drive, and the like.

The inkjet printer 3 prints an image on the web W while conveying the web W unwound from the unwinder 2. The inkjet printer 3 includes a conveyor 21, printers 22A, 22B, and a printer controller 23. Note that the printers 22A, 22B may be collectively referred to by omitting the alphabets attached to the reference numeral.

The conveyor 21 conveys the web W unwound from the unwinder 2. The conveyor 21 includes guide rollers 31 to 40, 20 under-head rollers 41, a skewing controller 42, the pair of conveyance rollers 43, and a conveyance motor 44.

The guide rollers 31, 32 guide the web W between the unwinder 2 and the skewing controller 42. The guide roller 31 is disposed in a lower portion of a left end portion of the inkjet printer 3. The guide roller 32 is disposed on the lower right side of the guide roller 31.

The guide rollers 33 to 39 guide the web W between the skewing controller 42 and the pair of conveyance rollers 43. The guide roller 33 is disposed slightly above and on the left side of a skewing control roller 47 in the skewing controller 42 to be described later. The guide roller 34 is disposed above the guide roller 33. The guide roller 35 is disposed on the right side of the guide roller 34 at the same height as the guide roller 34. The guide roller 36 is disposed below the guide roller 35 and above the guide roller 33. The guide roller 37 is on the left side of the guide roller 36, near and on the right side of the web W between the guide rollers 33, 34, at substantially the same height as the guide roller 36. The guide roller 38 is disposed on the lower right side of the guide roller 37. The guide roller 39 is disposed below and slightly on the right side of the guide roller 38.

The guide roller 40 guides the web W between the pair of conveyance rollers 43 and the rewinder 4. The guide roller 40 is disposed in a lower portion of a right end portion of the inkjet printer 3.

The under-head rollers 41 support the web W under head units 51 to be described later in an area between the guide rollers 34, 35 and an area between the guide rollers 36, 37. Ten under-head rollers 41 are disposed in each of the area between the guide rollers 34, 35 and the area between the guide rollers 36, 37. Moreover, two under-head rollers 41 are disposed for each head unit 51.

In each of the area between the guide rollers 34, 35 and the area between the guide rollers 36, 37, ten under-head rollers 41 are disposed in an arch pattern protruding upward. Specifically, the under-head rollers 41 are disposed as follows. In each of the area between the guide rollers 34, 35 and the area between the guide rollers 36, 37, the two under-head rollers 41 below the center one of the five head units 51 are disposed at the same height. Moreover, in each of the area between the guide rollers 34, 35 and the area between the guide rollers 36, 37, the five under-head rollers 41 on the left side are disposed at levels that become lower and lower toward the left, and the five under-head rollers 41 on the right side are disposed at levels that become lower and lower toward the right.

Conveying the web W along the under-head rollers 41 disposed in the arch shape as described above causes the web W to be tensioned between the adjacent under-head rollers 41 below each head unit 51 and the attitude of the web W is stabilized.

The skewing controller 42 corrects skewing which is fluctuation in the position of the web Win the width direction thereof (front-rear direction). The skewing controller 42 includes skewing control rollers 46, 47.

The skewing control rollers 46, 47 are rollers for guiding the web Wand correcting the skewing of the web W. The skewing control rollers 46, 47 are turned by a not-illustrated motor to be tilted with respect to the width direction of the web W as viewed in the left-right direction and thereby move the web W in the width direction to correct the skewing. The skewing control roller 46 is disposed on the right side of the guide roller 32. The skewing control roller 47 is disposed above the skewing control roller 46.

The pair of conveyance rollers 43 conveys the web W toward the rewinder 4 while nipping the web W. The pair of conveyance rollers 43 is disposed between the guide rollers 39, 40.

The conveyance motor 44 rotationally drives the conveyance rollers 43.

The printers 22A, 22B perform printing respectively on a front surface and a back surface of the web W. Each of the printers 22A, 22B includes five head units 51, an ink circulation mechanism. 52, and five ink temperature sensors 53.

The head units 51 print images by discharging inks to the web W. In each of the printers 22A, 22B, the five head units 51 eject inks of different colors, respectively, to the web W. The five head units 51 of the printer 22A are disposed above and near the web W between the guide rollers 34, 35. The five head units 51 of the printer 22B are disposed above and near the web W between the guide rollers 36, 37.

The head units 51 are installed along an arch-shaped conveyance route formed by the under-head rollers 41 disposed in the arch pattern as described above. Specifically, each head unit 51 is installed such that nozzle surfaces 66a of a later-described inkjet heads 66 included in the head unit 51 are parallel to the web W between the two under-head rollers 41 below the head unit 51. In other words, each head unit 51 is installed such that the head height direction which is a direction orthogonal to the nozzle surfaces 66a in the head unit 51 is orthogonal to the web W between the two under-head rollers 41 below the head unit 51. The reason for this is to secure an appropriate head gap.

As illustrated in FIGS. 2 and 3, each head unit 51 includes a print bar 56, a lifting-lowering motor 57, two base portions 58, two base motors 59, a maintenance unit 60, and a movement motor 61.

The print bar 56 includes ten inkjet heads 66, a head base 67, two wall portions 68, and two supported portions 69.

As illustrated in FIG. 4, each inkjet head 66 has two nozzle rows 71. The two nozzle rows 71 each have multiple nozzles 72 arranged at a predetermined pitch in the front-rear direction (main scanning direction). The positions of the nozzles 72 in the front-rear direction in one of the two nozzle rows 71 are shifted by half pitch from those in the other nozzle row 71.

The nozzles 72 are opened in the nozzle surfaces 66a which are surfaces (lower surfaces) of the inkjet heads 66 facing the web W, and eject the ink to the web W. The nozzles 72 eject the ink in the direction orthogonal to the nozzle surfaces 66a.

Ink repellent films are formed on the nozzle surfaces 66a of the inkjet heads 66. The ink repellent films are made of a material with a property of repelling the ink and are made of, for example, an amorphous fluoropolymer.

The inkjet heads 66 are disposed in zigzag in the front-rear direction in the print bar 56. Specifically, in the print bar 56, two head rows in each of which five inkjet heads 66 are disposed at predetermined intervals in the front-rear direction are arranged in the left-right direction with the positions of the inkjet heads 66 in the front-rear direction shifted from one another.

The head base 67 holds the inkjet heads 66. The head base 67 is made of a rectangular plate-shaped member. Attachment opening portions for attaching the inkjet heads 66 are formed in the head base 67. The inkjet heads 66 are inserted into and fixed to the attachment opening portions such that the nozzle surfaces 66a protrude downward from the head base 67.

The wall portions 68 support the supported portions 69. The wall portions 68 are provided to stand respectively in a front end portion and a rear end portion of the head base 67.

The supported portions 69 are members supported by the base portions 58 when the print bar 56 is disposed at a standby position. One of the two supported portions 69 is provided to stand from a front face of the front wall portion 68 and the other supported portion 69 is provided to stand from a rear face of the rear wall portion 68.

Here, the standby position of the print bar 56 is the position of the print bar 56 in the standby state where the print system 1 is not operating. The standby position of the print bar 56 is above a print position which is the position of the print bar 56 in the printing. The print bar 56 is configured to be capable of being lifted and lowered in the head height direction. Note that the print bar 56 in FIG. 3 is in a state where the print bar 56 is disposed at the standby position.

The lifting-lowering motor 57 lifts and lowers the print bar 56.

The base portions 58 support the supported portions 69 to align the print bar 56 at the standby position. One of the two base portions 58 supports the front supported portion 69 and the other base portion 58 supports the rear supported portion 69. The base portions 58 support the supported portions 69 such that a head tilt angle θ (see FIGS. 5 and 6) in the case where the print bar 56 is at the standby position is the same as the head tilt angle θ in the case where the print bar 56 is at the print position, the head tilt angle θ being a tilt angle of the nozzle surfaces 66a with respect to a horizontal plane. The base portions 58 are configured to be capable of being retreated from a lifting-lowering path of the print bar 56 by being turned about rotation shafts 58a.

The base motors 59 turn the base portions 58 about the rotation shafts 58a. The base motors 59 are provided respectively for the two base portions 58.

As described above, each head unit 51 are installed such that the nozzle surfaces 66a of the inkjet heads 66 included in the head unit 51 are parallel to the web W between the two under-head rollers 41 below the head unit 51. Accordingly, in each printer 22, the inkjet heads 66 in the four head units 51 not including the center head unit 51 are installed such that the nozzle surfaces 66a thereof are tilted in the left-right direction (conveyance direction of the web W) with respect to the horizontal plane. The head tilt angle θ in the case where the print bar 56 is at the print position is the same as that in the case where the print bar 56 is at the standby position. Note that the nozzle surfaces 66a are not tilted in the front-rear direction.

Specifically, for example, as illustrated in FIGS. 5 and 6, the leftmost head unit 51 and the second head unit 51 from the left are installed such that the nozzle surfaces 66a of the inkjet heads 66 are tilted downward with respect to the horizontal plane while extending to the left. The head tilt angle θ is the same as the tilt angle of the web W facing the nozzle surfaces 66a with respect to the horizontal plane.

FIG. 5 is a front view of the head unit 51 in the standby state of the print system 1 and is a view of a state where the print bar 56 is disposed at the standby position. As described later, in the standby state, the maintenance unit 60 is disposed at a deployed position directly below the print bar 56 as illustrated in FIG. 5.

Moreover, FIG. 6 is a front view of the head unit 51 in the printing and is a view of a state where the print bar 56 is disposed at the print position. The print bar 56 is aligned at the print position by causing the head base 67 to be supported on an alignment member (not illustrated) provided in the conveyor 21. Moreover, as described later, in the printing, the maintenance unit 60 is disposed at a retreat position behind the print bar 56.

Note that the tilt angle of the web W below the second head unit 51 from the left is smaller than the tilt angle of the web W below the leftmost head unit 51. Accordingly, the head tilt angle θ of the second head unit 51 from the left is smaller than that of the leftmost head unit 51.

Moreover, although omitted in the drawings, the rightmost head unit 51 and the second head unit 51 from the right are installed such that the nozzle surfaces 66a of the inkjet heads 66 are tilted downward with respect to the horizontal plane while extending to the right. Moreover, the head tilt angle θ of the second head unit 51 from the right is smaller than that of the rightmost head unit 51.

The maintenance unit 60 cleans the nozzle surfaces 66a of the inkjet heads 66. As illustrated in FIGS. 7 and 8, the maintenance unit 60 includes an ink receptor 76 and a wiper unit 77.

The ink receptor 76 receives the ink and the like removed from the nozzle surfaces 66a by wiping performed in the maintenance by wipers 82 to be described later. The ink receptor 76 has a tray shape which is rectangular in a plan view. The ink receptor 76 is provided such that a planar bottom plate 76a is orthogonal to the head height direction.

The wiper unit 77 wipes the nozzle surfaces 66a of the inkjet heads 66 to remove the ink and the like on the nozzle surfaces 66a. The wiper unit 77 includes a wiper attachment base 81 and two wipers 82.

The wiper attachment base 81 is a member to which the wipers 82 are attached. The wiper attachment base 81 is disposed at a front end portion of the ink receptor 76.

The wipers 82 are members which wipe the nozzle surfaces 66a of the inkjet heads 66. The wipers 82 are made of an elastically-deformable material such as rubber and are formed in a planar rectangular plate shape. The wipers 82 are attached to the wiper attachment base 81 such that upper ends thereof protrude upward beyond an upper end of the wiper attachment base 81 and upper end edges thereof are parallel to the bottom plate 76a of the ink receptor 76. One of the two wipers 82 wipes the nozzle surfaces 66a of the inkjet heads 66 in one of the head rows of the print bar 56 and the other wiper 82 wipes the nozzle surfaces 66a of the inkjet heads 66 in the other head row.

When the maintenance unit 60 moves reward from the deployed position directly below the print bar 56 to the retreat position, the wipers 82 come into contact with the inkjet heads 66 and wipe the nozzle surfaces 66a to which the ink discharged from the nozzles 72 by the purging is attached (adhered).

In each of the head units 51 in which the nozzle surfaces 66a are tilted, the orientation of the wipers 82 with respect to the wiping direction is set such that the wipers 82 are tilted toward the downstream side (rear side) in the wiping direction (front-rear direction) while extending to the lower side in the tilt direction (left-right direction) of the nozzle surfaces 66a.

FIG. 8 illustrates a main portion of the maintenance unit 60 in each of the head units 51 in which the nozzle surfaces 66a are tilted downward while extending to the left. Specifically, in the leftmost head unit 51 and the second head unit 51 from the left, the nozzle surfaces 66a are tilted downward while extending to the left as described above. Accordingly, in the leftmost head unit 51 and the second head unit 51 from the left, as illustrated in FIG. 8, the wipers 82 are attached to the wiper attachment base 81 to be tilted rearward while extending to the left.

Meanwhile, in the rightmost head unit 51 and the second head unit 51 from the right, the nozzle surfaces 66a are tilted downward while extending to the right as described above. Accordingly, in the rightmost head unit 51 and the second head unit 51 from the right, the wipers 82 are attached to the wiper attachment base 81 to be tilted rearward while extending to the right as opposite to the wipers 82 illustrated in FIG. 8.

As described above, the wipers 82 are tilted toward the downstream side (rear side) in the wiping direction while extending to the lower side in the tilt direction of the nozzle surfaces 66a and this allows the wipers 82 to wipe the nozzle surfaces 66a while pushing the ink attached to the nozzle surfaces 66a from the lower side to the upper side in the tilt direction of the nozzle surfaces 66a in the wiping. In other words, the entire wipers 82 in the maintenance unit 60 of each head unit 51 in which the nozzle surfaces 66a are tilted correspond to ink pushing-up wiping portions.

Note that, in the center head unit 51 of each printer 22, since the nozzle surfaces 66a are not tilted (parallel to the left-right direction), the wipers 82 are attached to the wiper attachment base 81 to be parallel to the left-right direction.

The orientation of the wipers 82 in each head unit 51 in which the nozzle surfaces 66a are tilted is set depending on the head tilt angle θ.

Specifically, in each head unit 51 in which the nozzle surfaces 66a tilted, the greater the head tilt angle θ is, the greater the tilt angle α of the wipers 82 with respect to the left-right direction is set, the left-right direction being the direction orthogonal to the wiping direction.

For example, the head tilt angle θ of the leftmost head unit 51 is greater than that of the second head unit 51 from the left. Accordingly, the tilt angle α of the wipers 82 in the leftmost head unit 51 is greater than that in the second head unit 51 from the left. Moreover, the head tilt angle θ of the rightmost head unit 51 is greater than that of the second head unit 51 from the right. Accordingly, the tilt angle α of the wipers 82 in the rightmost head unit 51 is greater than that in the second head unit 51 from the right.

The greater the head tilt angle θ is, the more likely the ink discharged from the nozzles 72 by the purging and attached to the nozzle surfaces 66a is to run down due to gravity. Meanwhile, the greater the tilt angle α of the wipers 82 is, the easier it is for the wipers 82 to push the ink toward the upper side of the nozzle surfaces 66a in the wiping.

Accordingly, increasing the tilt angle α of the wipers 82 with an increase in the head tilt angle θ as described above suppresses the case where the wipers 82 cannot sufficiently push up the ink running to the lower side of the nozzle surfaces 66a.

The tilt angle α of the wipers 82 set depending on the head tilt angle θ is an angle set based on, for example, experiments and the like.

The movement motor 61 in each head unit 51 moves the maintenance unit 60 between the deployed position and the retreat position. The deployed position of the maintenance unit 60 is the position of the maintenance unit 60 in the standby state of the print system 1 and is the position directly below the print bar 56 as illustrated in FIG. 9. The retreat position of the maintenance unit 60 is the position of the maintenance unit 60 in the printing and is the position retreated from the deployed position to the rear side as illustrated in FIG. 10.

The ink circulation mechanism 52 supplies the inks to the inkjet heads 66 of the head units 51 while circulating the inks. The ink circulation mechanism 52 has ink circulation routes (not illustrated) for the respective color inks and supplies the corresponding color ink to each head unit 51 while circulating the color inks. Moreover, the ink circulation mechanism 52 includes a temperature adjustment mechanism (not illustrated) which adjusts the temperature of each color ink.

Furthermore, the ink circulation mechanism 52 includes a pressure generation mechanism (not illustrated) which generates pressure for circulating the color inks along the respective ink circulation routes. The pressure generation mechanism can generate purging pressure in the inkjet heads 66 in the purging performed in the maintenance of the inkjet heads 66. Moreover, the ink circulation mechanism 52 is configured to be capable of adjusting the purging pressure and the purging time for each head unit 51. The ink circulation mechanism 52 thus includes a purging unit which performs the purging.

Each of the ink temperature sensors 53 detects the temperature of the ink to be supplied to the inkjet heads 66. Five ink temperature sensors 53 are provided respectively for the five head units 51. Specifically, one ink temperature sensors 53 is provided for each of the ink circulation routes of the respective color inks in the ink circulation mechanism 52. The ink temperature detected by each ink temperature sensor 53 is used for ink temperature adjustment performed by the temperature adjustment mechanism in the ink circulation mechanism 52. Moreover, the ink temperature detected by each ink temperature sensor 53 is also used to adjust the purging pressure and the purging time in the maintenance.

The printer controller 23 controls operations of the parts of the inkjet printer 3. The printer controller 23 includes a CPU, a RAM, a ROM, a hard disk drive, and the like.

The rewinder 4 rewinds the web W subjected to printing in the inkjet printer 3. The rewinder 4 includes a rewinding shaft 91, a rewinding motor 92, and a rewinder controller 93.

The rewinding shaft 91 rewinds and holds the web W.

The rewinding motor 92 rotates the rewinding shaft 91 clockwise in FIG. 1. Rotation of the rewinding shaft 91 causes the web W to be rewound on the rewinding shaft 91.

The rewinder controller 93 controls drive of the rewinding motor 92. The rewinder controller 93 includes a CPU, a RAM, a ROM, a hard disk drive, and the like.

Next, operations in the printing by the print system. 1 are described.

In the standby state before the start of the print operation by the print system 1, each print bar 56 is disposed at the standby position and each maintenance unit 60 is disposed at the deployed position. Note that, in this state, the upper ends of the wipers 82 are above the nozzle surfaces 66a.

In the printing, when a print job is inputted, the printer controller 23 moves the maintenance unit 60 to the retreat position and moves the print bar 56 to the print position.

Specifically, the printer controller 23 controls the lifting-lowering motor 57 to cause it to lift the print bar 56 to a predetermined height above the standby position. The nozzle surfaces 66a are thereby disposed above the upper ends of the wipers 82.

Next, the printer controller 23 controls the movement motor 61 to cause it to move the maintenance unit 60 from the deployed position to the retreat position. Then, the printer controller 23 controls the lifting-lowering motor 57 to cause it to lower the print bar 56 to the print position. In this case, the printer controller 23 causes the base motors 59 to turn the base portions 58 and retreat the base portions 58 from the lifting-lowering path of the print bar 56.

Next, the unwinder controller 13, the printer controller 23, and the rewinder controller 93 start the conveyance of the web W.

Specifically, the unwinder controller 13 starts the drive of the brake 12, the printer controller 23 starts the drive of the conveyance motor 44, and the rewinder controller 93 starts the drive of the rewinding motor 92. The web W is thereby conveyed from the unwinder 2 to the rewinder 4. Application of braking force to the web roll support shaft 11 by the brake 12 of the unwinder 2 causes the web W to be conveyed with tension applied to the web W between the web roll 16 and the pair of conveyance rollers 43.

After the start of the conveyance of the web W, the printer controller 23 controls the inkjet heads 66 based on the print job to cause them to print images on the web W while causing the ink circulation mechanism 52 to supply the inks to the inkjet heads 66.

When the printing based on the print job is completed, the unwinder controller 13, the printer controller 23, and the rewinder controller 93 terminate the conveyance of the web W. Specifically, the unwinder controller 13 stops the brake 12, the printer controller 23 stops the conveyance motor 44, and the rewinder controller 93 stops the rewinding motor 92.

Thereafter, the printer controller 23 returns the maintenance unit 60 and the print bar 56 to the positions in the standby state of the print system 1. In other words, the printer controller 23 disposes the maintenance unit 60 at the deployed position and disposes the print bars 56 at the standby position.

Specifically, first, the printer controller 23 controls the lifting-lowering motor 57 to cause it to lift the print bar 56 to the predetermined height above the standby position. In this case, the printer controller 23 causes the base motors 59 to turn the base portions 58 and retreat the base portions 58 from the lifting-lowering path of the print bar 56.

Next, the printer controller 23 controls the movement motor 61 to cause it to move the maintenance unit 60 from the retreat position to the deployed position. Next, the printer controller 23 controls the base motors 59 to cause them to return the base portions 58 to the state where the base portions 58 can support the supported portions 69 of the print bar 56.

Then, the printer controller 23 controls the lifting-lowering motor 57 to cause it to lower the print bar 56 to the standby position. The series of operations is thereby completed.

Next, operations in the maintenance of the inkjet heads 66 in the inkjet printer 3 are described.

At the start of the maintenance of the inkjet heads 66, each print bar 56 is disposed at the standby position and each maintenance unit 60 is disposed at the deployed position.

In this state, the printer controller 23 performs the purging. Specifically, the printer controller 23 controls the ink circulation mechanism 52 to cause it to generate the purging pressure in the inkjet heads 66 and discharge the ink from the nozzles 72. The ink is thereby pushed out from the nozzles 72 of the inkjet heads 66 and is attached to the nozzle surfaces 66a.

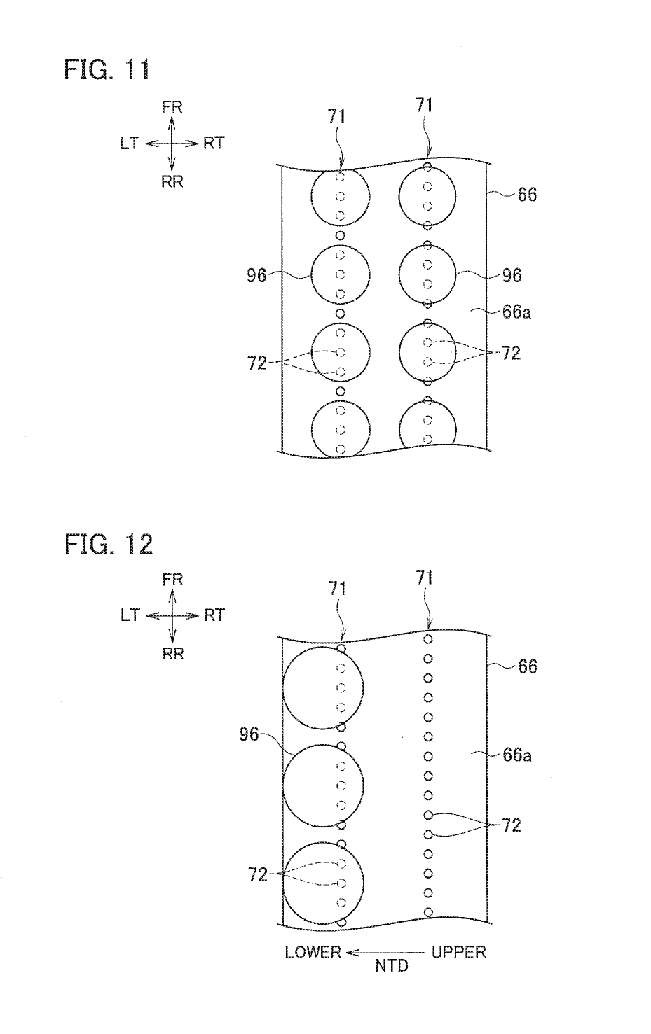

As illustrated in FIG. 11, droplets of ink 96 are thereby attached onto the nozzle surfaces 66a along the nozzle rows 71. In each inkjet head 66 whose nozzle surface 66a is tilted, the ink 96 on the nozzle surface 66a runs to the lower side of the nozzle surface 66a in the tilt direction thereof due to gravity. The ink 96 discharged from the nozzle row 71 on the upper side in the tilt direction of the nozzle surface 66a is thereby combined with the ink 96 discharged from the nozzle row 71 on the lower side and, as illustrated in FIG. 12, the ink 96 gathers on the lower side of the nozzle surface 66a in the tilt direction thereof.

In this case, in each head unit 51 in which the nozzle surfaces 66a are tilted, the amount of ink discharged from the nozzles 72 by the purging is adjusted depending on the head tilt angle θ.

The ink discharged by the purging from the nozzles 72 in each inkjet head 66 whose nozzle surface 66a is tilted runs to the lower side of the nozzle surface 66a in the tilt direction thereof due to gravity as described above. In this case, some of the ink drops from the nozzle surface 66a. In this regard, the smaller the head tilt angle θ is, the fewer the ink which drops from the nozzle surface 66a due to tilt of the nozzle surface 66a is, relative to the ink discharged from the nozzles 72 by the purging. Accordingly, in each head unit 51 in which the nozzle surfaces 66a are tilted, the amount of ink discharged from the nozzles 72 by the purging is adjusted such that the smaller the head tilt angle θ is, the smaller the amount of discharged ink is. This can prevent the ink from being excessively discharged in the purging.

For example, the amount of ink discharged from the nozzles 72 by purging in the second head unit 51 from the left is set to be smaller than that in the leftmost head unit 51. Similarly, the amount of ink discharged from the nozzles 72 by purging in the second head unit 51 from the right is set to be smaller than that in the rightmost head unit 51.

The amount of ink discharged from the nozzles 72 by the purging is adjusted by adjusting at least one of the purging time and the purging pressure generated in the inkjet heads 66 by the ink circulation mechanism 52.

In this case, the higher the temperature of the ink supplied to the inkjet head 66 in the purging is, the lower the viscosity of the ink is, and thus more ink tends to be discharged from the nozzles 72. Accordingly, in the purging, the printer controller 23 controls the ink circulation mechanism 52 such that the ink circulation mechanism 52 adjusts at least one of the purging pressure and the purging time based on the temperature of the ink detected in each head unit 51 by the corresponding ink temperature sensor 53 to discharge a desired amount of ink.

When the purging is completed, the printer controller 23 controls the movement motor 61 to cause it to move the maintenance unit 60 from the deployed position to the retreat position. In this movement, the wipers 82 come into contact with the inkjet heads 66 and wipe the nozzle surfaces 66a.

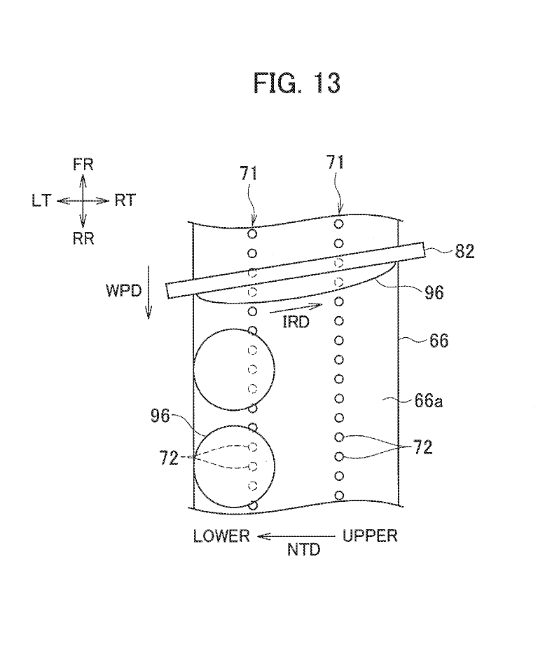

In this case, in each head unit 51 in which the nozzle surfaces 66a are tilted, since the wipers 82 are tilted as described above, as illustrated in FIG. 13, the ink 96 on the nozzle surfaces 66a is pushed from the lower side to the upper side in the tilt direction of the nozzle surfaces 66a along the wipers 82. The entire nozzle surfaces 66a are thereby wiped with the ink which acts as lubricant being present between the nozzle surfaces 66a and the wipers 82, even when the ink gathers on the lower side of the nozzle surfaces 66a in the tilt direction thereof before the wiping.

After the maintenance unit 60 moves while wiping the nozzle surfaces 66a and reaches the retreat position, the printer controller 23 returns the maintenance unit 60 to the deployed position.

Specifically, first, the printer controller 23 controls the lifting-lowering motor 57 to cause it to lift the print bar 56 to the predetermined height above the standby position. The nozzle surfaces 66a are thereby disposed above the upper ends of the wipers 82.

Next, the printer controller 23 controls the movement motor 61 to cause it to move the maintenance unit 60 from the retreat position to the deployed position.

Then, the printer controller 23 controls the lifting-lowering motor 57 to cause it to lower the print bar 56 to a standby height position. The operations in the maintenance of the inkjet heads 66 are thus completed.

As described above, in the inkjet printer 3, in each head unit 51 in which the nozzle surfaces 66a are tilted, the wipers 82 tilted toward the downstream side in the wiping direction while extending to the lower side in the tilt direction of the nozzle surfaces 66a wipe the nozzle surfaces 66a while pushing the ink attached to the nozzle surfaces 66a from the lower side to the upper side in the tilt direction of the nozzle surfaces 66a. This can reduce the possibility of the nozzle surfaces 66a being wiped without the ink which acts as lubricant being present between the nozzle surfaces 66a and the wipers 82 on the upper side of the nozzle surfaces 66a in the tilt direction thereof. As a result, it is possible to mitigate degradation of the ink repellent films on the nozzle surfaces 66a of the inkjet heads 66.

Moreover, in the inkjet printer 3, in each head unit 51 in which the nozzle surfaces 66a are tilted, the amount of ink discharged from the nozzles 72 by the purging is adjusted depending on the head tilt angle θ. This prevents the ink from being excessively discharged in the purging and wasting of the ink can be thus suppressed.

Note that, in the aforementioned embodiment, the wipers 82 are formed of the planar plate-shaped members. Moreover, in each head unit 51 in which the nozzle surfaces 66a are tilted, the orientation of the wipers 82 is set such that the wipers 82 are tilted toward the downstream side in the wiping direction while extending to the lower side in the tilt direction of the nozzle surfaces 66a to be wiped by the wipers 82.

However, the wipers of the maintenance unit 60 in each head unit 51 in which the nozzle surfaces 66a are tilted may have a shape curved toward the downstream side in the wiping direction while extending to the lower side in the tilt direction of the nozzle surfaces 66a.

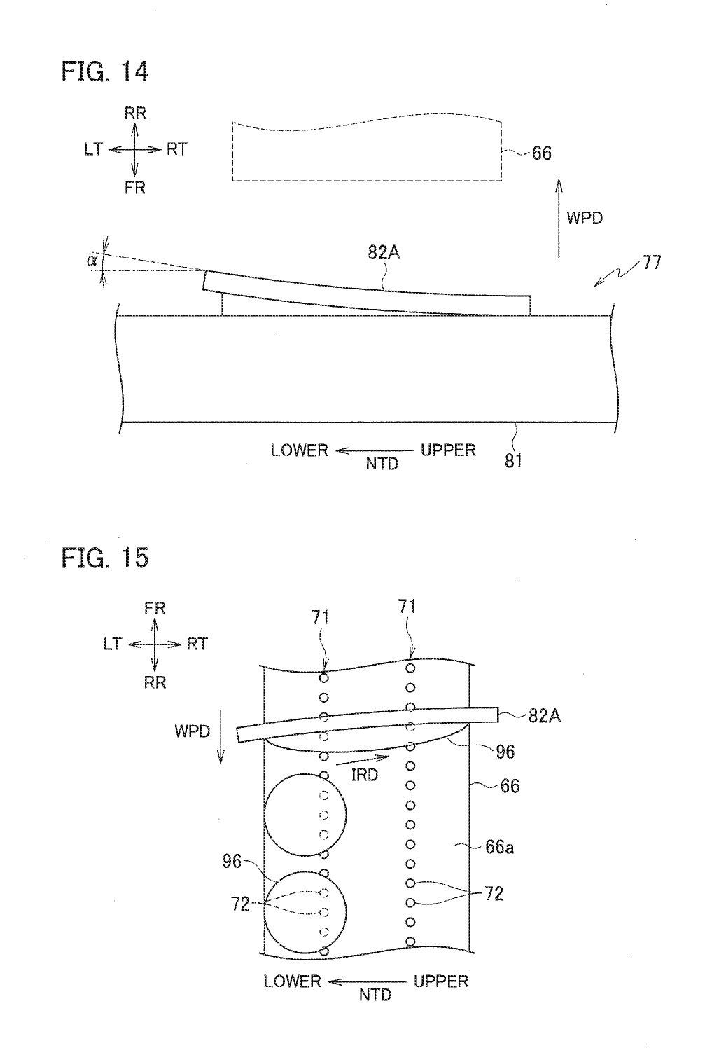

FIG. 14 is a view illustrating a wiper 82A with a curved shape as described above. The wiper 82A illustrated in FIG. 14 is formed in an arc shape curved to protrude upstream in the wiping direction to extend rearward while extending to the left. Specifically, FIG. 14 illustrates the wipers 82A in the head units 51 (the leftmost head unit 51 and the second head unit 51 from the left) in which the nozzle surfaces 66a are tilted downward while extending to the left. In the head units 51 (the rightmost head unit 51 and the second head unit 51 from the right) in which the nozzle surfaces 66a are tilted downward while extending to the right, the wipers 82A are each formed in a curved shape protruding upstream in the wiping direction to extend rearward while extending to the right as opposite to FIG. 14. Note that the entire wipers 82A correspond to the ink pushing-up wiping portions.

In each of the wipers 82A, the tilt angle, with respect to the left-right direction, of a tangent at an end of the wiper 82A on the lower side in the tilt direction of the nozzle surfaces 66a is referred to as the tilt angle α of the wiper 82A with respect to the left-right direction. In each maintenance unit 60 using the wipers 82A, the tilt angle α of the wipers 82A is set depending on the head tilt angle θ as in the aforementioned embodiment. Specifically, the greater the head tilt angle θ is, the greater the tilt angle α of the wipers 82A is set.

Also in the wiping by the wipers 82A, as illustrated in FIG. 15, the ink 96 on the nozzle surfaces 66a are pushed from the lower side to the upper side in the tilt direction of the nozzle surfaces 66a along the wipers 82A. This can reduce the possibility of the nozzle surfaces 66a being wiped without the ink which acts as lubricant being present between the nozzle surfaces 66a and the wipers 82A on the upper side of the nozzle surfaces 66a. As a result, it is possible to mitigate degradation of the ink repellent films on the nozzle surfaces 66a of the inkjet heads 66.

Moreover, the wipers of the maintenance units 60 in the head units 51 in which the nozzle surfaces 66a are tilted may be each configured such that a portion of the wiper including a wiper end on the lower side in the tilt direction of the nozzle surfaces 66a is a portion which is tilted toward the downstream side in the wiping direction while extending to the lower side in the tilt direction of the nozzle surfaces 66a and the wiper wipes the nozzle surfaces 66a while pushing the ink attached to the nozzle surfaces 66a from the lower side to the upper side in the tilt direction of the nozzle surfaces 66a.

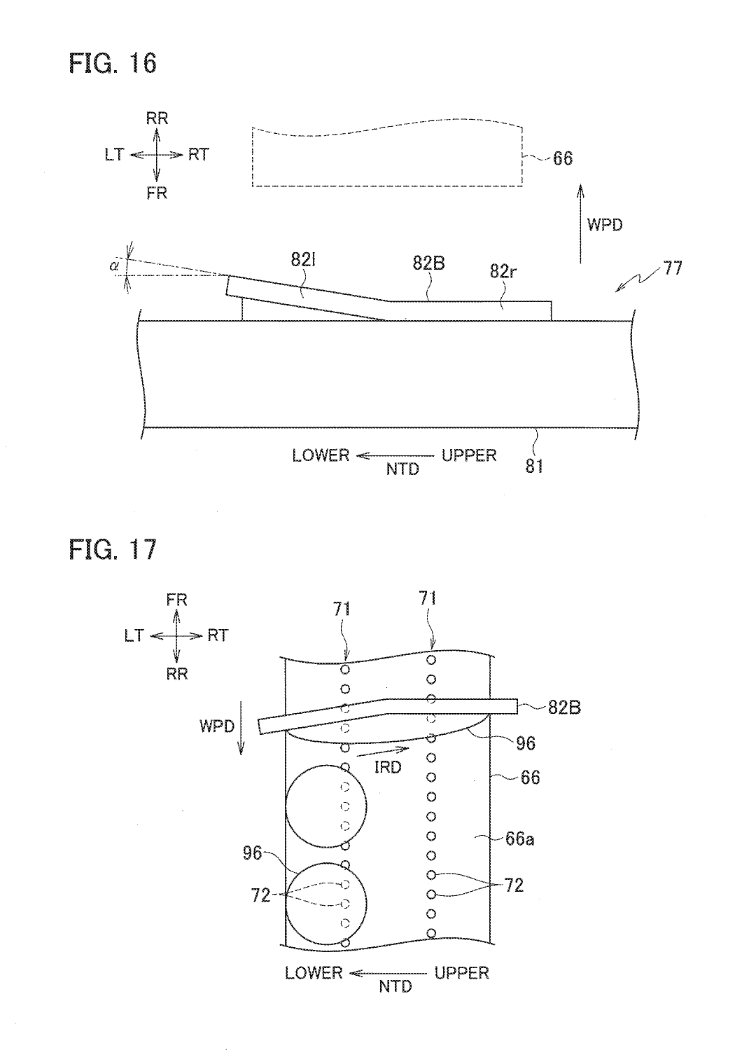

FIG. 16 is a view illustrating a wiper 82B in which a portion of the wiper including a wiper end on the lower side in the tilt direction of the nozzle surfaces 66a is tilted toward the downstream side in the wiping direction while extending to the lower side in the tilt direction of the nozzle surfaces 66a as described above. The wiper 82B is formed by connecting two planar plate-shaped portions 821, 82r such that the plate-shaped portions 821, 82r forma predetermined angle, and has a shape bent in a center portion in the left-right direction.

The wiper 82B illustrated in FIG. 16 is formed such that the left plate-shaped portion 821 is tilted rearward while extending to the left and the right plate-shaped portion 82r is parallel to the left-right direction. Specifically, FIG. 16 illustrates the wipers 82B in the head units 51 (the leftmost head unit 51 and the second head unit 51 from the left) in which the nozzle surfaces 66a are tilted downward while extending to the left. In the head units 51 (the rightmost head unit 51 and the second head unit 51 from the right) in which the nozzle surfaces 66a are tilted downward while extending to the right, the wipers 82B are each formed such that the right plate-shaped portion 82r is tilted rearward while extending to the right and the left plate-shaped portion 821 is parallel to the left-right direction. Note that, in each wiper 82B, one of the plate-shaped portions 821, 82r on the lower side in the tilt direction of the nozzle surfaces 66a corresponds to the ink pushing-up wiping portion.

In each of the wipers 82B, the tilt angle, with respect to the left-right direction, of one of the plate-shaped portions 821, 82r on the lower side in the tilt direction of the nozzle surfaces 66a is referred to as the tilt angle α of the wiper 82B with respect to the left-right direction. In each maintenance unit 60 using the wipers 82B, the tilt angle α of the wipers 82B is set depending on the head tilt angle θ as in the aforementioned embodiment. Specifically, the greater the head tilt angle θ is, the greater the tilt angle α of the wipers 82B is set.

Also in the wiping by the wipers 82B, as illustrated in FIG. 17, the ink 96 on the nozzle surfaces 66a are pushed from the lower side to the upper side in the tilt direction of the nozzle surfaces 66a along the tilted portions (left plate-shaped portion 821 in the example of FIG. 17) of the wipers 82B. This can reduce the possibility of the nozzle surfaces 66a being wiped without the ink which acts as lubricant being present between the nozzle surfaces 66a and the wipers 82B on the upper side of the nozzle surfaces 66a. As a result, it is possible to mitigate degradation of the ink repellent films on the nozzle surfaces 66a of the inkjet heads 66.

Note that one of the plate-shaped portions 821, 82r on the lower side in the tilt direction of the nozzle surfaces 66a in each wiper 82B may have a shape curved toward the downstream side in the wiping direction while extending to the lower side in the tilt direction of the nozzle surfaces 66a. Each wiper only needs to be configured such that at least a portion of the wiper including the wiper end on the lower side in the tilt direction of the nozzle surfaces 66a is the ink pushing-up wiping portion which is tilted or curved toward the downstream side in the wiping direction while extending to the lower side in the tilt direction and the wiper wipes the nozzle surfaces 66a while pushing the ink attached to the nozzle surfaces 66a from the lower side to the upper side in the tilt direction of the nozzle surfaces 66a.

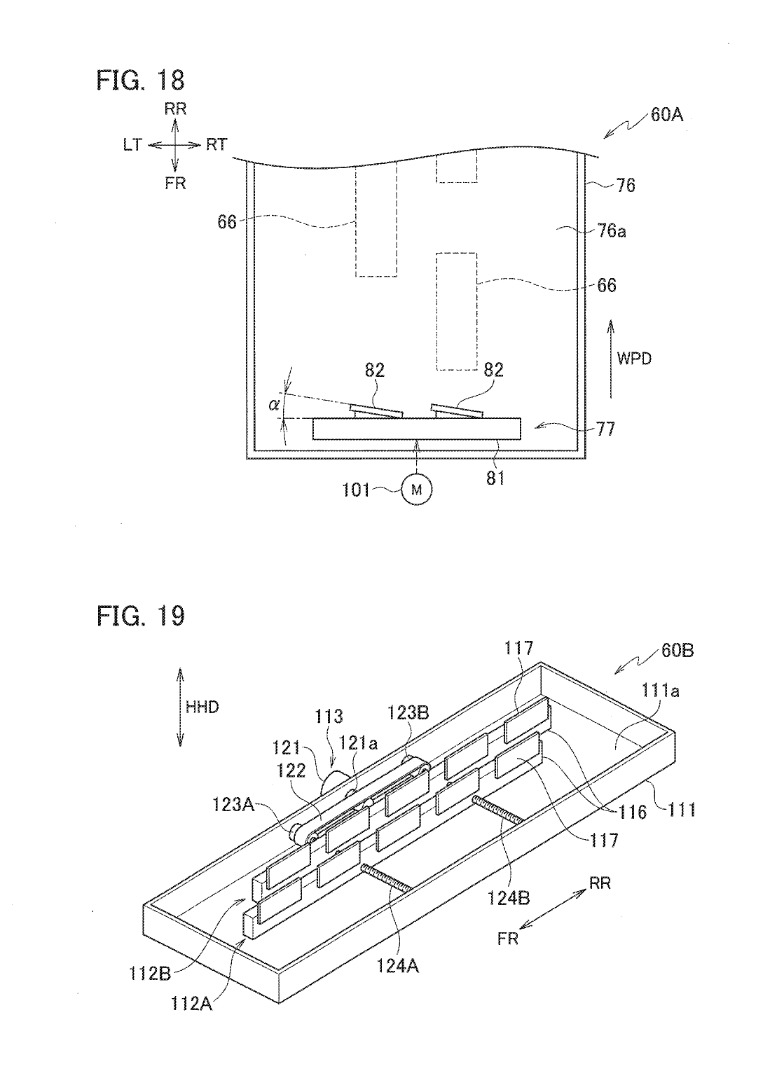

Next, description is given of a second embodiment in which the maintenance units of the aforementioned first embodiment are changed. FIG. 18 is an enlarged plan view of a main portion of each of maintenance units in the second embodiment.

As illustrated in FIG. 18, each of the maintenance units 60A in the second embodiment has a configuration in which an adjustment motor (adjuster) 101 is added to the maintenance unit 60 in the aforementioned first embodiment. Moreover, the wiper attachment base 81 of the maintenance unit 60A is configured to be turnable about a rotation axis orthogonal to the bottom plate 76a of the ink receptor 76.

The adjustment motor 101 turns the wiper attachment base 81 about the rotation axis orthogonal to the bottom plate 76a of the ink receptor 76 to adjust the orientation of the wipers 82.

In the second embodiment, the orientation of the wipers 82 in each head unit 51 in which the nozzle surfaces 66a are tilted is adjusted depending on the temperature of the ink supplied to the inkjet heads 66. Specifically, in each head unit 51 in which the nozzle surfaces 66a are tilted, the adjustment is performed such that the higher the temperature of the ink supplied to the inkjet heads 66 is, the greater the tilt angle α of the wipers 82 is set.

The higher the temperature of the ink is, the lower the viscosity of the ink is and the ink attached to the nozzle surfaces 66a tends to run down. Meanwhile, the greater the tilt angle α of the wipers 82 is, the easier it is for the wipers 82 to push the ink toward the upper side of the nozzle surfaces 66a in the wiping. Accordingly, increasing the tilt angle α of the wipers 82 with an increase in the temperature of the ink as described above suppresses the case where the wipers 82 cannot sufficiently push up the ink running to the lower side of the nozzle surfaces 66a.

The tilt angle α of the wipers 82 (orientation of the wipers 82) depending on the temperature of the ink in each head unit 51 in which the nozzle surfaces 66a are tilted is determined in advance based on experiments and the like for each of multiple temperature ranges of the ink.

In the maintenance, the printer controller 23 controls the adjustment motor 101 to cause it to adjust the tilt angle α of the wipers 82 in each head unit 51 in which the nozzle surfaces 66a are tilted such that the tilt angle α is set to an angle depending on the ink temperature detected by the ink temperature sensor 53.

Note that, in the center head unit 51 in each printer 22, the nozzle surfaces 66a are not tilted and the wipers 82 are fixed in the orientation in which the tilt angle α is 0 degrees. Accordingly, the center head unit 51 may be configured such that the orientation of the wipers 82 cannot be adjusted.

As described above, in the second embodiment, in each head unit 51 in which the nozzle surfaces 66a are tilted, the orientation of the wipers 82 with respect to the wiping direction is adjusted depending on the temperature of the ink supplied to the inkjet heads 66. The higher the ink temperature is, the lower the viscosity of the ink is and the ink tends to flow to the lower side of the nozzle surfaces 66a. In this respect, this configuration can suppress the case where the wipers 82 cannot sufficiently push up the ink running to the lower side. As a result, it is possible to reduce the possibility of the nozzle surfaces 66a being wiped without the ink being present between the nozzle surfaces 66a and the wipers 82 on the upper side of the nozzle surfaces 66a. Accordingly, it is possible to mitigate degradation of the ink repellent films on the nozzle surfaces 66a of the inkjet heads 66.

Note that, in the second embodiment, as in the first embodiment, the wipers attached to the wiper attachment base 81 may have a curved shape like the aforementioned wiper 82A in FIG. 14 or a bent shape like the aforementioned wiper 82B in FIG. 16.

The wiper may be configured such that the tilt angle, with respect to the left-right direction, of only one of the plate-shaped portions 821, 82r in the wiper 82B of FIG. 16 which is on the lower side in the tilt direction of the nozzle surfaces 66a is adjusted depending on the temperature of the ink supplied to the inkjet heads 66.

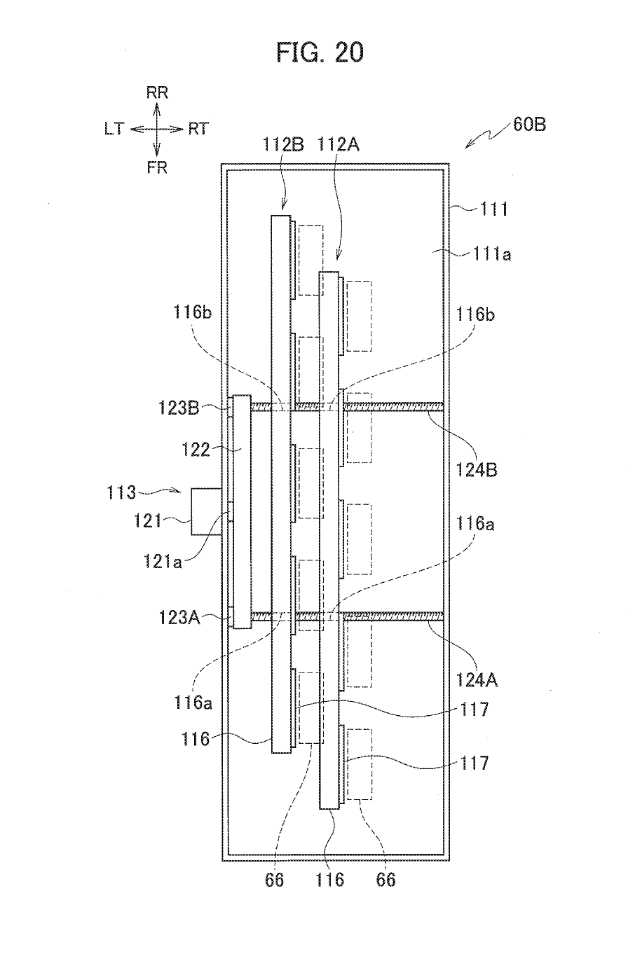

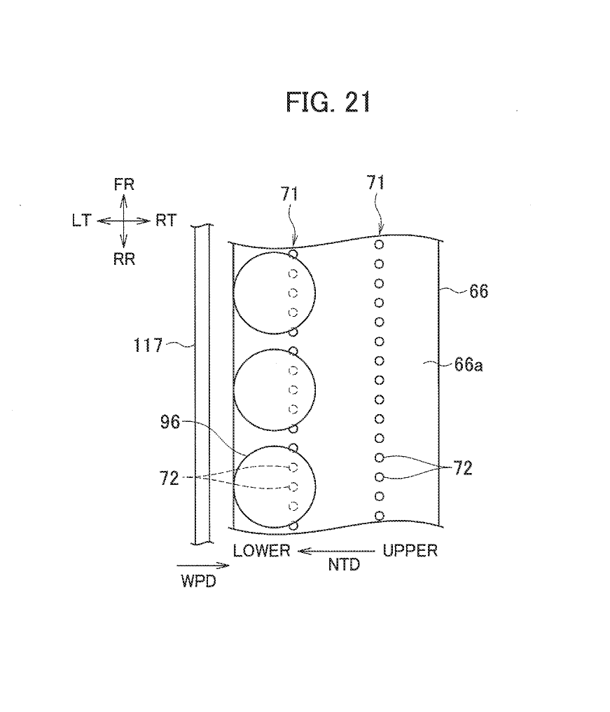

Next, description is given of a third embodiment in which the maintenance units of the aforementioned first embodiment are changed. FIG. 19 is a perspective view illustrating a schematic configuration of each of maintenance units in the third embodiment. FIG. 20 is a plan view of the maintenance unit illustrated in FIG. 19.

As illustrated in FIGS. 19 and 20, each of the maintenance units 60B in the third embodiment includes an ink receptor 111, wiper units 112A, 112B, and a wiper driver 113.

Here, the maintenance units 60B in the leftmost head unit 51 and the second head unit 51 from the left in which the nozzle surfaces 66a are tilted downward while extending to the left are installed with their orientation turned by 180 degrees in the plan view from the orientation of the maintenance units 60B in the rightmost head unit 51 and the second head unit 51 from the right in which the nozzle surfaces 66a are tilted downward while extending to the right.

Note that the orientation of the maintenance unit 60B in the center head unit 51 may be the same as the orientation of the maintenance units 60B in the head units 51 in which the nozzle surfaces 66a are tilted downward while extending to the left or as the orientation of the maintenance units 60B in the head units 51 in which the nozzle surfaces 66a are tilted downward while extending to the right.

FIGS. 19 and 20 illustrate the maintenance unit 60B installed in the orientation in the head units 51 in which the nozzle surfaces 66a are tilted downward while extending to the left. In the following description, the configuration of the maintenance unit 60B is described based on the state where the maintenance unit 60B is installed in the orientation in the head units 51 in which the nozzle surfaces 66a are tilted downward while extending to the left.

The ink receptor 111 receives the ink and the like removed from the nozzle surfaces 66a by wiping performed in the maintenance by wipers 117 to be described later. The ink receptor 111 has a tray shape which is rectangular in a plan view. The ink receptor 111 is provided such that a planar bottom plate 111a is orthogonal to the head height direction.

The wiper units 112A, 112B wipe the nozzle surfaces 66a of the inkjet heads 66 to remove the ink and the like on the nozzle surfaces 66a. The wiper units 112A, 112B are arranged in the left-right direction to be parallel to each other and the wiper unit 112A is arranged on the right side of the wiper unit 112B. The wiper units 112A, 112B each include a wiper attachment base 116 and five wipers 117.

The wiper attachment bases 116 are members to which the wipers 117 are attached. Five wipers 117 are attached to each wiper attachment base 116 while being arranged in the front-rear direction. A pair of screw holes 116a, 116b is formed in each wiper attachment base 116. Threaded shafts 124A, 124B to be described later are inserted in the respective screw holes 116a, 116b to be screwed thereto. Rotation of the threaded shafts 124A, 124B causes the wiper attachment bases 116 to move in a direction parallel to the bottom plate 111a of the ink receptor 111 and orthogonal to the front-rear direction.

The wipers 117 are members which wipe the nozzle surfaces 66a of the inkjet heads 66. The wipers 117 are made of elastically-deformable material such as rubber and are formed in a planar rectangular plate shape. The wipers 117 are attached to the wiper attachment bases 116 such that upper ends thereof protrude upward beyond upper ends of the wiper attachment bases 116 and upper end edges thereof are parallel to the bottom plate 111a of the ink receptor 111. The five wipers 117 of the wiper unit 112A wipe the nozzle surfaces 66a of the inkjet heads 66 in the right head row in the print bar 56, respectively. The five wipers 117 of the wiper unit 112B wipe the nozzle surfaces 66a of the inkjet heads 66 in the left head row in the print bar 56, respectively. The wipers 117 wipe the nozzle surfaces 66a while moving in the direction orthogonal to the front-rear direction.

The wiper driver 113 moves the wiper units 112A, 112B. The wiper driver 113 includes a wiper motor 121, a drive belt 122, a pair of drive pulleys 123A, 123B, and the pair of threaded shafts 124A, 124B.

The wiper motor 121 generates rotating drive force for moving the wiper units 112A, 112B. The wiper motor 121 is disposed outside a left side wall of the ink receptor 111. The wiper motor 121 includes an output gear 121a. The output gear 121a transmits the rotating drive force of the wiper motor 121 to the drive belt 122. The output gear 121a is disposed in a center portion of the drive belt 122.

The drive belt 122 transmits the rotating drive force transmitted from the wiper motor 121 to the drive pulleys 123A, 123B. The drive belt 122 is wound around the drive pulley 123A and the drive pulley 123B.

The pair of drive pulleys 123A, 123B transmits the rotating drive force transmitted from the drive belt 122 to the threaded shafts 124A, 124B, respectively. The drive pulley 123A and the drive pulley 123B are disposed at the same height at a predetermined interval in the front-rear direction. The drive pulleys 123A, 123B are rotatably supported on the left side wall of the ink receptor 111.

The threaded shafts 124A, 124B move the wiper units 112A, 112B by using the rotating drive force transmitted from the drive pulleys 123A, 123B. The threaded shafts 124A, 124B extend over substantially the entire distance between the left side wall and a right side wall of the ink receptor 111. Left ends of the threaded shafts 124A, 124B are fixed to the drive pulleys 123A, 123B, respectively. Right ends of the threaded shafts 124A, 124B are rotatably supported on the right side wall of the ink receptor 111. The threaded shafts 124A, 124B thereby rotate together with the drive pulleys 123A, 123B, respectively.

In the third embodiment, in each head unit 51 in which the nozzle surfaces 66a are tilted, when the maintenance unit 60B is disposed at the deployed position, as illustrated in FIG. 20, the wiper units 112A, 112B are disposed near and on the lower side of the inkjet heads 66 in the tilt direction of the nozzle surfaces 66a, the inkjet heads 66 provided in the wipe rows to be wiped respectively by the wiper units 112A, 112B.

In the center head unit 51, when the maintenance unit 60B is disposed at the deployed position, the wiper units 112A, 112B are disposed near and on the left or right side of the inkjet heads 66 provided in the wipe rows to be wiped respectively by the wiper units 112A, 112B.

Moreover, when the maintenance unit 60B is disposed at the deployed position, the upper ends of the wipers 117 are located above the nozzle surfaces 66a.

In the maintenance, the printer controller 23 performs the purging as in the first embodiment to attach the ink to the nozzle surfaces 66a with the maintenance unit 60B disposed at the deployed position. Then, the printer controller 23 controls the wiper driver 113 to cause it to move the wiper units 112A, 112B toward the inkjet heads 66 to be wiped.

In each head unit 51 in which the nozzle surfaces 66a are tilted, as illustrated in FIG. 21, the wipers 117 thereby wipe the nozzle surfaces 66a from the lower side to the upper side in the tilt direction of the nozzle surfaces 66a. The wipers 117 thereby wipe the nozzle surfaces 66a while pushing the ink 96 from the lower side to the upper side of the nozzle surfaces 66a.

When the wipers 117 pass the nozzle surfaces 66a being the wiping targets, the printer controller 23 stops the wiper units 112A, 112B.

Then, the printer controller 23 controls the lifting-lowering motor 57 to cause it to lift the print bar 56 to a predetermined height above the standby position. The nozzle surfaces 66a are thereby disposed above the upper ends of the wipers 117.

Next, the printer controller 23 controls the wiper driver 113 to cause it to return the wiper units 112A, 112B to the positions before the wiping.

Then, the printer controller 23 controls the lifting-lowering motor 57 to cause it to lower the print bar 56 to the standby height position. The operations in the maintenance of the inkjet heads 66 are thereby completed.

As described above, in the third embodiment, the wipers 117 wipe the nozzle surfaces 66a from the lower side to the upper side in the tilt direction of the nozzle surfaces 66a. The wipers 117 thereby wipe the nozzle surfaces 66a while pushing the ink from the lower side to the upper side of the nozzle surfaces 66a. Accordingly, it is possible to reduce the possibility of the nozzle surfaces 66a being wiped without the ink which acts as lubricant being present between the nozzle surfaces 66a and the wipers 117 on the upper side of the nozzle surfaces 66a in the tilt direction thereof. As a result, it is possible to mitigate degradation of the ink repellent films on the nozzle surfaces 66a of the inkjet heads 66.

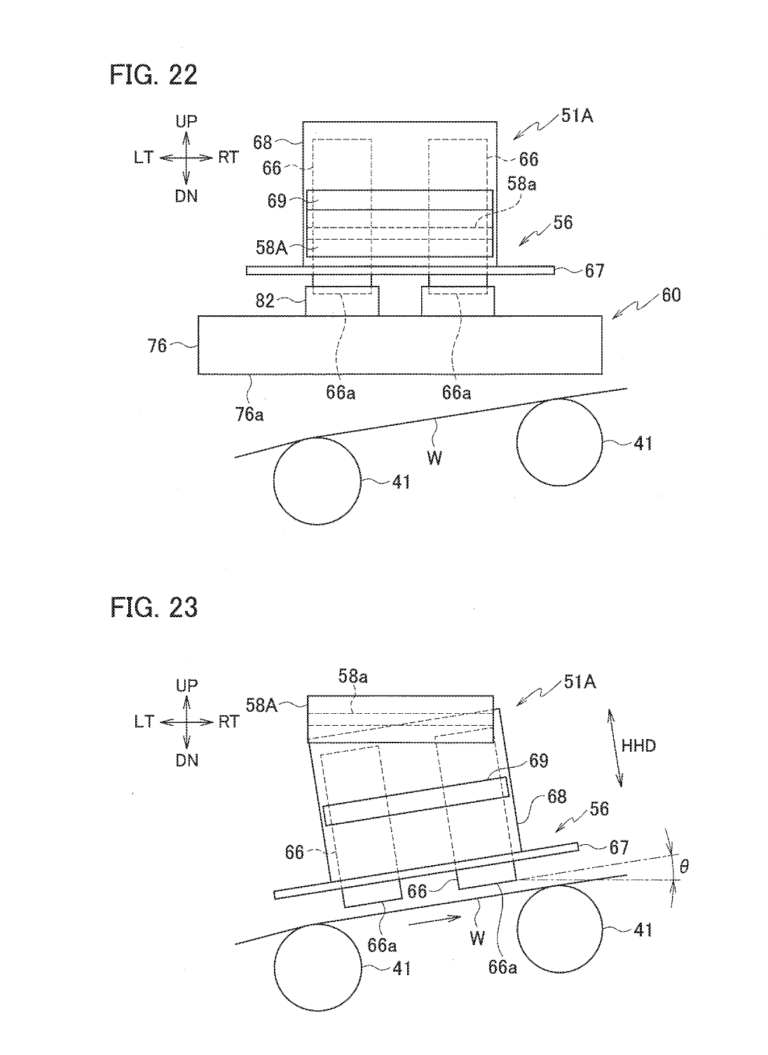

Next, description is given of a fourth embodiment in which the head units of the aforementioned first embodiment are changed. FIG. 22 is a front view of the head unit in the fourth embodiment in the standby state. FIG. 23 is a front view of the head unit in the fourth embodiment in the printing.

As illustrated in FIGS. 22 and 23, each of head units 51A in the fourth embodiment has a configuration in which the base portions 58 in the head unit 51 of the aforementioned first embodiment are replaced by base portions 58A.

Moreover, in the head unit 51A, as illustrated in FIG. 22, the maintenance unit 60 is provided such that the bottom plate 76a is horizontal. Furthermore, in the maintenance unit 60 of the head unit 51A, the wipers 82 are attached to the wiper attachment base 81 to be parallel to the left-right direction.

The base portions 58A support the supported portions 69 to align the print bar 56 at the standby position with the nozzle surfaces 66a being horizontal. Thus, in the fourth embodiment, the nozzle surfaces 66a are horizontal when the print bar 56 is at the standby position also in each head unit 51A in which the nozzle surfaces 66a are tilted when the print bar 56 is at the print position.

Specifically, in each printer 22, the inkjet heads 66 in the four head units 51A not including the center head unit 51A are set in the printing such that the nozzle surfaces 66a are tilted with respect to the horizontal plane and are set in the maintenance such that the nozzle surfaces 66a are horizontal.

Moreover, the base portions 58A are configured to be capable of retreating from the lifting-lowering path of the print bar 56 by being turned about the rotation shafts 58a.

FIGS. 22 and 23 are front views of the head unit 51A in which the nozzle surfaces 66a are tilted downward while extending to the left in the printing. Although illustration is omitted, in the standby state, the print bar 56 is supported at the standby position with the nozzle surfaces 66a being horizontal also in each head unit 51A in which the nozzle surfaces 66a are tilted downward while extending to the right in the printing.

In the fourth embodiment, at the start of the maintenance of the inkjet heads 66, as illustrated in FIG. 22, the print bar 56 is disposed at the standby position and the nozzle surfaces 66a are set to be horizontal. Moreover, the maintenance unit 60 is disposed at the deployed position.

In this state, the printer controller 23 performs the purging to attach the ink to the nozzle surfaces 66a. Since the nozzle surfaces 66a are not tilted, a state where droplets of the ink are attached onto the nozzle surfaces 66a along the nozzle rows 71 is maintained.

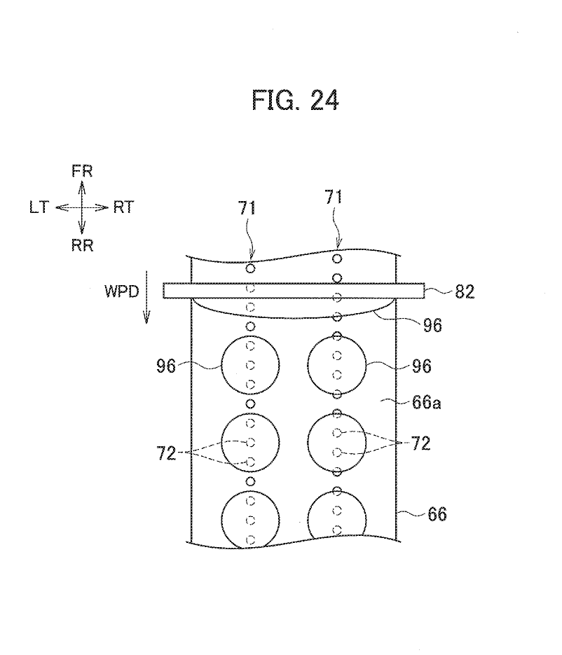

When the purging is completed, the printer controller 23 controls the movement motor 61 to cause it to move the maintenance unit 60 from the deployed position to the retreat position. In this movement, as illustrated in FIG. 24, the wipers 82 wipe the nozzle surfaces 66a to which the ink 96 are attached.

As described above, in the fourth embodiment, in each of the head units 51A in which the nozzle surfaces 66a are set to be tilted in the printing, the nozzle surfaces 66a are set to be horizontal in the maintenance. Then, the printer controller 23 performs control to attach the ink to the nozzle surfaces 66a by performing the purging with the nozzle surfaces 66a being horizontal and to cause the wipers 82 to wipe the nozzle surfaces 66a to which the ink is attached. Accordingly, it is possible to avoid the case where the nozzle surfaces 66a are wiped without the ink being present between the nozzle surfaces 66a and the wipers on the upper side of the nozzle surfaces 66a in the tilt direction thereof, which occurs when the purging and the wiping are performed with the nozzle surfaces 66a being tilted. As a result, it is possible to mitigate degradation of the ink repellent films on the nozzle surfaces 66a of the inkjet heads 66.

Note that, although the configuration in which the wipers 82 wipe the nozzle surfaces 66a in the direction (front-rear direction) parallel to the nozzle rows 71 is explained in the aforementioned description, the wiping direction is not limited to this. For example, the configuration may be such that the wipers wipe the nozzle surfaces 66a in the direction (left-right direction) orthogonal to the nozzle rows 71.

Although the configuration in which the unwinder and the rewinder are connected to the inkjet printer as separate devices is explained in the aforementioned first to fourth embodiments, the configuration may be such that the unwinder and the rewinder are incorporated in the inkjet printer.

Although the configuration in which each inkjet head 66 has two nozzle rows 71 is described in the aforementioned first to fourth embodiment, the number of nozzle rows included in each inkjet head is not limited to this. Moreover, the print medium is not limited to the long web.

The embodiments of the present disclosure have, for example, the following configurations.

An inkjet printer includes: an inkjet head including nozzles configured to eject ink, and a nozzle surface on which the nozzles open and an ink repellent film is formed, the nozzle surface tilted in a tilt direction with respect to a horizontal plane; a purging unit configured to discharge the ink from the nozzles and attach the discharged ink to the nozzle surface; and a wiper configured to wipe the nozzle surface in a wiping direction orthogonal to the tilt direction with the nozzle surface to which the ink discharged from the nozzles by the purging unit is attached. At least a portion of the wiper including an end of the wiper on a lower side in the tilt direction is tilted or curved toward a downstream side in the wiping direction toward the lower side in the tilt direction, and the portion of the wiper is configured to wipe the nozzle surface while pushing the ink attached to the nozzle surface from the lower side to an upper side in the tilt direction.

The inkjet printer above may further include an adjuster configured to adjust an orientation of the wiper with respect to the wiping direction depending on a temperature of the ink supplied to the inkjet head.

An inkjet printer includes: an inkjet head including nozzles configured to eject ink, and a nozzle surface on which the nozzles open and an ink repellent film is formed, the nozzle surface tilted in a tilt direction with respect to a horizontal plane; a purging unit configured to discharge the ink from the nozzles and attach the discharged ink to the nozzle surface; and a wiper configured to wipe the nozzle surface from a lower side to an upper side in the tilt direction with the nozzle surface to which the ink discharged from the nozzles by the purging unit is attached.

The purging unit may be configured to adjust an amount of the ink to be discharged from the nozzles depending on a tilt angle of the nozzle surface.

An inkjet printer includes: an inkjet head including nozzles configured to eject ink, and a nozzle surface on which the nozzles open and an ink repellent film is formed, the nozzle surface set to tilt with respect to a horizontal plane in printing and be horizontal in maintenance; a purging unit configured to discharge the ink from the nozzles of the inkjet head with the nozzle surface being horizontal and attach the ink to the nozzle surface; and a wiper configured to wipe the nozzle surface of the inkjet head with the nozzle surface being horizontal and to which the ink discharged from the nozzles by the purging unit is attached.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. An inkjet printer comprising:
an inkjet head including
nozzles configured to eject ink, and
a nozzle surface on which the nozzles open and an ink repellent film is formed, the nozzle surface tilted in a tilt direction with respect to a horizontal plane;
a purging unit configured to discharge the ink from the nozzles and attach the discharged ink to the nozzle surface; and
a wiper configured to wipe the nozzle surface in a wiping direction orthogonal to the tilt direction with the nozzle surface to which the ink discharged from the nozzles by the purging unit is attached, wherein
at least a portion of the wiper including an end of the wiper on a lower side in the tilt direction is tilted or curved toward a downstream side in the wiping direction toward the lower side in the tilt direction, and the portion of the wiper is configured to wipe the nozzle surface while pushing the ink attached to the nozzle surface from the lower side to an upper side in the tilt direction.

2. The inkjet printer according to claim 1, further comprising an adjuster configured to adjust an orientation of the wiper with respect to the wiping direction depending on a temperature of the ink supplied to the inkjet head.

3. An inkjet printer comprising:
an inkjet head including
nozzles configured to eject ink, and
a nozzle surface on which the nozzles open and an ink repellent film is formed, the nozzle surface tilted in a tilt direction with respect to a horizontal plane;
a purging unit configured to discharge the ink from the nozzles and attach the discharged ink to the nozzle surface; and
a wiper configured to wipe the nozzle surface from a lower side to an upper side in the tilt direction with the nozzle surface to which the ink discharged from the nozzles by the purging unit is attached.

4. The inkjet printer according to claim 1, wherein the purging unit is configured to adjust an amount of the ink to be discharged from the nozzles depending on a tilt angle of the nozzle surface.

5. The inkjet printer according to claim 2, wherein the purging unit is configured to adjust an amount of the ink to be discharged from the nozzles depending on a tilt angle of the nozzle surface.

6. The inkjet printer according to claim 3, wherein the purging unit is configured to adjust an amount of the ink to be discharged from the nozzles depending on a tilt angle of the nozzle surface.

7. An inkjet printer comprising:
an inkjet head including
nozzles configured to eject ink, and
a nozzle surface on which the nozzles open and an ink repellent film is formed, the nozzle surface set to tilt with respect to a horizontal plane in printing and be horizontal in maintenance;
a purging unit configured to discharge the ink from the nozzles of the inkjet head with the nozzle surface being horizontal and attach the ink to the nozzle surface; and
a wiper configured to wipe the nozzle surface of the inkjet head with the nozzle surface being horizontal and to which the ink discharged from the nozzles by the purging unit is attached.
